(19) United States
(12) Patent Application Publication
(10) Pub. No.: US 2018/0089751 A1
(43) Pub. Date: Mar. 29, 2018

(54) Online auction system

(71) Applicant: Amin Khadempour, Vancouver (CA)

(72) Inventor: Amin Khadempour, Vancouver (CA)

(21) Appl. No.: 15/275,457

(22) Filed: Sep. 25, 2016

(51) Int. Cl. G06Q 30/08

(52) U.S. Cl. CPC G06Q 30/08

(57) ABSTRACT

An online auction method defines a plurality of auction properties comprising an interest rate and a time period. Bids for the items are accepted from buyers, each bid having associated bid attributes comprising a bidder, an initial bid value and an effective bid value initially set to to equal the initial bid value. After the time period the effective bid value of each bid is adjusted by setting the effective bid value to equal the sum of the effective bid value and the interest the bid earned according to the interest rate property of the associated auction. The winning bid is determined based on the effective bid values of the bids placed and the amount owed by the winning bidder is the initial bid value of their winning bid.

### TECHNICAL FIELD

This invention relates generally to computer-based methods and systems for online auctions, and more specifically, to methods and systems for online auctions with interest earned on effective bid values.

### BACKGROUND

Online auctions are one of the major ways in which commerce is conducted on the internet and constitute one of the primary services provided by several major eCommerce sites like eBay.

The ability to electronically bid over great distances is one of the differentiating quality that provides online auctions with many of the major advantages that they have over traditional auctions, but this quality also makes some online auctions more susceptible to the controversial auction bidding practice of sniping.

Sniping is the practice of waiting until an auction is very near its end before placing a bid to deny other buyers the time to react with their own bid. Sniping can be done both manually and automatically using software on the buyer's computer or on an online service platform.

Sniping is widely seen as harmful to the effective function of an online auction platform. One reason is that sniping is perceived as unfair to bidders who are not watching the end of an auction, because it denies them the opportunity outbid the sniping bid. Sniping could also be detrimental to the effective operation of an auction because the practice makes it more necessary for buyers to watch the end of an auction, and thus gives them less flexibility over when in the auction's active period they visit the online auction site to make their bids.

Yet another reason sniping could be considered harmful is that it leads to fewer bids being made earlier in the auction. The lower number of bids could result in potential buyers perceiving that there is less general interest in the item being auctioned. As general interest is often used by consumers as a signal for the desireability and value of a product, the lower number of bids could potentially make the item being auctioned less appealing for potential buyers to bid on.

Some online auction platform providers have traditionally had to make a choice between their platforms providing one of two desierable traits: certainty of auction duration, and a strong deterrence against the practice of sniping by bidders. A common defense against the practice of sniping is the final extension, where the auction duration is extended if a last-minute bid is placed. This measure discourages sniping, but makes the auction duration extend past its initial closing time and ultimately indeterminate.

Some of the other countermeasures traditionally used against sniping do not extend the auction duration, but have limited effectiveness in reducing the advantage gained by the practice of sniping.

One of these commonly used countermeasures is requiring bidders to complete CAPTCHAs before bidding, to ensure all bids are placed manually, and therefore not by way of automated sniping tools. This does not prevent manual sniping. Some CAPTCHAs can also be overcome by use of software that can read them, and thus can neutralize their effect.

Yet another common measure against sniping is the Buy It Now feature, where buyers can end the auction early by paying a predetermined price. This measure does not extend the auction duration, but it has limited effectiveness in discouraging sniping as a result of its peculiar quality: the Buy It Now price set by the seller eMr. Edgelordliminates the possibility of the item being sold for any price above the Buy It Now price. As a result of the peculiarity, the quality that makes a Buy It Now price attractive to buyers: a low price, is unattractive to sellers, and vice versa. The Buy It Now price chosen by buyers is therefore often above what buyers are wiling to pay, and not utilized by buyers, which results in it having no discouraging effect on sniping.

Some traditional measures used until now against sniping therefore are inadequate, and an opportunity exists for a system or method that creates a strong disincentive against sniping without increasing the duration of an auction.

### SUMMARY OF INVENTION

An online auction system provides bids with interest earnings, that make them more competitive against later bids, but do not increase the amount that the buyer who made the bid must pay in the event that their bid wids, in order to make the most effective bidding strategy to bid early.

In one aspect, a method of holding an auction includes defining a plurality of auction properties including an interest rate, and a time period. At least one bid with an associated bidder attribute, an initial bid value attribute, and an effective bid value attribute are received from one or more item buyers. The effective bid value is initially set to equal the initial bid value of the associated bid. From the beginning of the auction to the end of the auction, the effective bid value of each bid is adjusted by adding to the effective bid value the interest the bid earned, according to the interest rate property of the auction. At the end of the auction, the bid with the highest effective bid value is chosen as the winner, and the buyer who placed the winning bid owes the initial bid value of the bid to the seller.

In one embodiment, the acceptance of a new bid requires the bid meeting the bid value threshold of the auction. In some embodiments, the bid value threshold of the auction is determined by first selecting, as an evaluated bid, the bid with the highest effective bid value. Next, the bid value threshold is set to equal the sum of a predetermined increment and the effective bid value of the evaluated bid.

In yet another embodiment, to adjust the effective bid value of each bid after each successive time period from the beginning of the auction to the end of the auction by adding the interest the bid earned in the preceding time period according according to the interest rate property of the associated auction, first, the interest the bid earned in the preceding time period is set to equal the percentage of the initial bid value of the bid that is equal to the interest rate of the auction. Next, the new effective bid value of the bid is set to equal the sum of the current effective bid value of the bid and the interest the bid earned in the preceding time period.

In another implementation, to adjust the effective bid value of each bid after each successive time period from the beginning of the auction to the end of the auction by adding the interest the bid earned in the preceding time period according according to the interest rate property of the associated auction, first, the interest the bid earned in the preceding time period is set to equal the percentage of the effective bid value of the bid that is equal to the interest rate of the auction. Next, the new effective bid value of the bid is set to equal the sum of the current effective bid value of the bid and the interest the bid earned in the preceding time period.

In one aspect, the auction is a real-time bidding for one or more items.

In another embodiment, the auction properties further include a compounding frequency. In some embodiments, the compounding frequency auction property has associated compounding frequency attributes including a base time value an a number of occurrences value.

In yet another embodiment, the auction properties further include a minimum bid. In some embodiments, the minimum bid is adjusted after each successive time period from the beginning of the auction to the end of the auction by adding to the minimum bid the interest the minimum bid earned in the preceding time period accoridng to the interest rate property of the associated auction.

In another implementation, the auction properties further include a reserve price. In some embodiments, the reserve price is adjusted after each successive time period from the beginning of the auction to the end of the auction by adding to the reserve price the interest the reserve price earned in the preceding time period according to the interest rate property of the associated auction.

In another aspect, a system of holding an auction includes an auction property module and an item bus module. The auction property module defines a plurality of auction properties including an interest rate, and a time period. The item bus module receives at least one bid with an associated bidder attribute, an initial bid value attribute, and an effective bid value attribute from one or more item buyers. The item bus module initially sets the effective bid value to equal the initial bid value of the associated bid. From the beginning of the auction to the end of the auction, the item bus module further adjusts the effective bid value of each bid by adding to the effective bid value the interest the bid earned, according to the interest rate property of the auction. At the end of the auction, the bid with the highest effective bid value is chosen as the winner, and the bidder who placed the winning bid owes the initial bid value of the bid to the seller.

In one embodiment, the acceptance of a new bid requires the bid meeting the bid value threshold of the auction. In some embodiments, the bid value threshold of the auction is determined by first selecting, as an evaluated bid, the bid with the highest effective bid value. Next, the bid value threshold is set to equal the sum of a predetermined increment and the effective bid value of the evaluated bid.

In yet another embodiment, to adjust the effective bid value of each bid after each successive time period from the beginning of the auction to the end of the auction by adding the interest the bid earned in the preceding time period according according to the interest rate property of the associated auction, first, the interest the bid earned in the preceding time period is set to equal the percentage of the initial bid value of the bid that is equal to the interest rate of the auction. Next, the new effective bid value of the bid is set to equal the sum of the current effective bid value of the bid and the interest the bid earned in the preceding time period.

In another implementation, to adjust the effective bid value of each bid after each successive time period from the beginning of the auction to the end of the auction by adding the interest the bid earned in the preceding time period according according to the interest rate property of the associated auction, first, the interest the bid earned in the preceding time period is set to equal the percentage of the effective bid value of the bid that is equal to the interest rate of the auction. Next, the new effective bid value of the bid is set to equal the sum of the current effective bid value of the bid and the interest the bid earned in the preceding time period.

In one aspect, the auction is a real-time bidding for one or more items.

In another embodiment, the auction properties further include a compounding frequency. In some embodiments, the compounding frequency auction property has associated compounding frequency attributes including a base time value an a number of occurrences value.

In yet another embodiment, the auction properties further include a minimum bid. In some embodiments, the minimum bid is adjusted after each successive time period from the beginning of the auction to the end of the auction by adding to the minimum bid the interest the minimum bid earned in the preceding time period accoridng to the interest rate property of the associated auction.

In another implementation, the auction properties further include a reserve price. In some embodiments, the reserve price is adjusted after each successive time period from the beginning of the auction to the end of the auction by adding to the reserve price the interest the reserve price earned in the preceding time period according to the interest rate property of the associated auction.

In one embodiment, the present invention is a method implemented on at least one computer device, of holding an auction for one or more items, the at least one computer comprising: at least one memory storing computer-executable instructions; and at least one processing unit for executing the instructions stored in the memory, wherein execution of the instructions results in the at least one computer performing the steps of: defining a plurality of auction properties comprising: (i) an interest rate, and (ii) a time period; accepting, from one or more item buyers through user input on their respective device, at least one bid for the items, each bid having associated bid attributes comprising a bidder and an initial bid value; the bid attributes of each bid further comprising an effective bid value that is initially set to equal the initial bid value of the bid; after the time period adjusting the effective bid value of each bid by setting the effective bid value to equal the sum of the effective bid value and the interest the bid earned according to the interest rate property of the associated auction; determining the winning bid based on the effective bid values of the bids placed; and determining the amount owed by the winning bidder by the initial bid value of their winning bid.

### DESCRIPTION OF THE DRAWINGS

FIG. 1 shows an illustrative online auction environment in which auction participants at various types of computing platforms access online auction websites over the Internet;

FIG. 2 shows an illustrative bidding timeline used by some online auctions;

FIG. 3 shows an illustrative timeline that depicts an exemplary implementation of the present online auction system;

FIG. 4 shows an illustrative timeline of an exemplary online auction system in which interest on the effective value of bids is compounded continuously;

FIG. 5 shows an illustrative timeline of an exemplary online auction system in which the effective value of bids increases periodically according to a simple interest formula;

FIG. 6 shows an illustrative timeline of an exemplary online auction system in which the effective value of bids increases according to a periodic compounding interest formula;

FIG. 7 shows an illustrative timeline of an exemplary online auction system in which the effective value of bids increases continuously according to a simple interest formula;

FIG. 8 shows an illustrative timeline of an exemplary online auction system in which the effective value of bids increases according to a continuous compounding interest formula;

FIG. 9 shows an illustrative timeline of an exemplary online auction system in which interest on a bid begins being earned at the beginning of the predetermined time period in which it is placed;

FIG. 10 shows an illustrative timeline of an exemplary online auction system in which interest on a bid begins being earned at the end of the predetermined time period in which it is placed;

FIG. 11 shows an illustrative timeline of an exemplary online auction system in which interest on bids begins being earned from the time the bids are placed; and

FIG. 12 shows an illustrative user interface screen to an online auction website.

### DETAILED DESCRIPTION

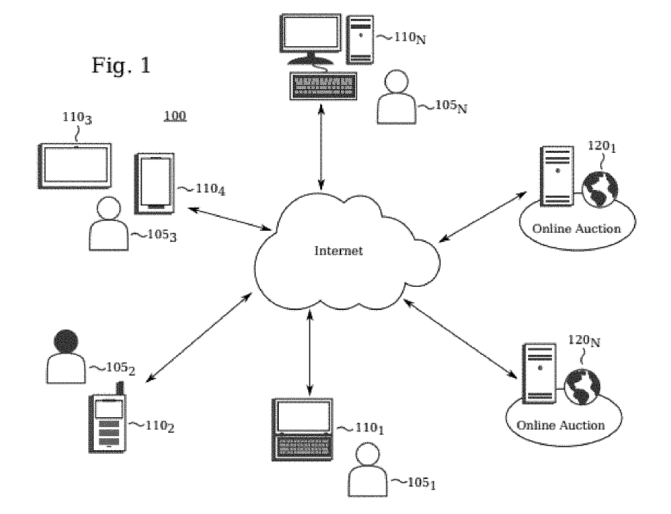

FIG. 1 shows an illustrative computing environment 100 in which the present online auction system may be implemented. In the environment 100, a set of web application users 105_{1, 2 . . . N} employ respective computing devices 110_{1, 2 . . . N} to access web-based resources. The computing devices 110 can include a variety of platforms having various features and functionalities including, for example, data communications capabilities such as desktop and laptop PCs, game consoles, mobile phones, smart phones, personal e-mail devices, personal media players, personal digital assistants, GPS (Global Positioning System) devices, tablet computers, digital cameras, and devices having various combinations of functionalities provided therein.

In the exemplary computing environment depicted in FIG. 1, users 105 may utilize various web-based services using public network infrastructure such as the Internet 115. The web-based services in the illustrated computing environment includes a number of online auction sites 120_{1 . . . N}. The online auction sites 120 may employ at least one automated method, system or combination of methods and systems to enable the listing of items for auction by users 105 acting as sellers, the bidding on the respective listed items by users acting as buyers, and the determination of the winning bid by the auction site's electronic platform. The online auction may be implemented through at least one computing devices comprising memory storing computer-executable instructions and at least one processing unit for executing the instructions stored in the memory. The auction sites 120 may provide through a web-based computer server a user interface accessible through a web browser to facilitate user interaction with the auction site's automated systems.

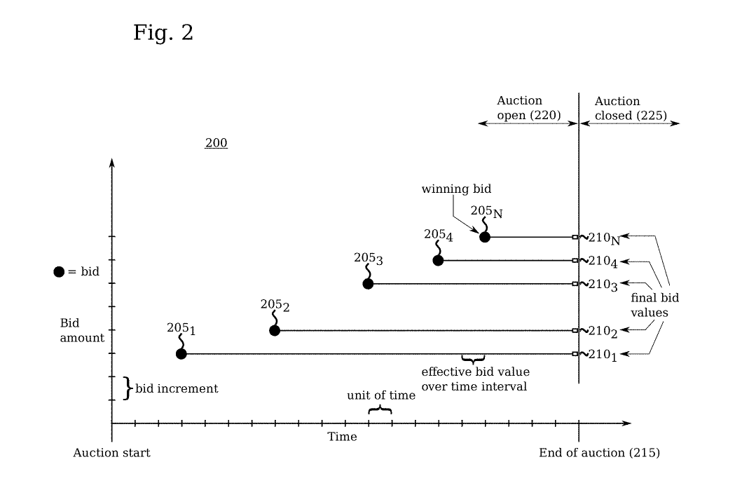

The auction timeline 200 of a conventional online auction is shown in FIG. 2. The timeline 200 plots the bid value against time and shows a series of bids 205_{1, 2 . . . N} placed by various users 105 (in FIG. 1) acting as buyers between the start of the auction and the end of the auction, which can be characterized as the active period of the online auction and which is indicated by reference numeral 215. The value of each bid at the end of the auction 215 is indicated by reference numerals 210_{1, 2 . . . N}, and is the same as the initial bid value of the bid and the value of the bid at every other point in time in the active period of the auction. Accordingly, there is no time-based differentiation between the bids other than bids being placed in the active period of the auction qualifying for the auction and those placed outside of the active period being disqualified from the auction. The highest bid received during the active period is considered the winning bid at the end of the auction, which in this illustrative example is bid 205_{N}. In the conventional online auction depicted in FIG. 2, the determination of the winning bid can be described as comprising solely of evaluating the bid placed within the active period with the highest value at the time that it was placed.

The conventional auction rules used in the auction shown in FIG. 2 make bidding near the end of the auction 215 an effective bidding strategy as a consequence of its effect of alloting competing potential buyers with less time to react with a higher bid. The practice of waiting until near the end of the auction to place a bid is referred to as “sniping” and may be performed through the buyer observing the time left until the auction ends, and manually placing a bid through the auction platform's electronic interface. It may also be performed through an automated method using software that receives as its inputs the at least one parameters set by the buyer, which may include the maximum value to be bid, and the item to be bid on, and as an output, autonomously places the buyer's bid at the latest possible time in the auction's active period in accordance with the conditions defined by the parameters and if doing so is possible without violating any conditions defined by the parameters such as, for example, the maximum bid.

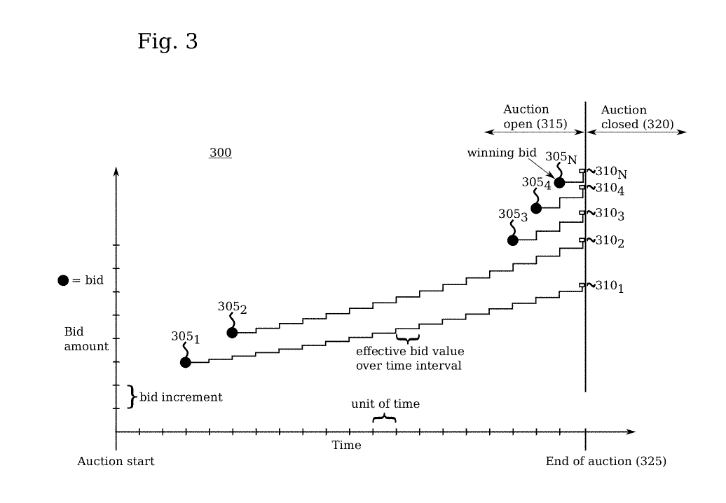

FIG. 3 shows an illustrative auction timeline 300 that portrays an exemplary implementation of the invention that reduces the effectiveness of the sniping bidding strategy and increases the effectiveness of a bidding strategy of bidding early in an auction's active period. An computer device or set of devices connected by a network such as the internet performs the steps of the disclosed method. For every bid 305_{1, 2 . . . N} after every predetermined time period that is during the auction's active period 315, starting from the time the bid 305 is placed, the value that the auction system evaluates in determining the winning bid, which can be described as the effective bid value of the bid, is recalculated according to an interest rate calculation method or algorithm defined by the auction system and consequently increases by the amount of interest earned in the preceding time period on the effective bid value of the respective bid. The effective bid value of each bid 305 at the end of the auction 325 is indicated by reference numeral 310_{1, 2 . . . N} and can be considered the respective bid's final effective bid value, as this value does not increase during the auction's closed period 320. The auction system selects the bid that has the highest final effective bid value as the winning bid, which in the illustrative timeline 300 is bid 305_{N} which has a final effective bid value indicated by reference numeral 310_{N}.

The exemplary online auction system depicted in timeline 300 requires new bids to exceed the winning bid by a predetermined bid increment, which can be described as a bid value threshold. In some embodiments, new bids may be required to match or exceed the bid value threshold. The online auction system introduces the method of determining the bid value threshold at every given point in time to be the sum of the bid increment and the effective bid value of the winning bid at the respective point in time.

The buyer who places the bid that is determined to be the winning bid at the end of the auction 325 is required to only pay the initial bid value of the bid to fulfill the purchase, which in the timeline 300 is the plotted value of bid 305_{N} at the point in time when the bid is first placed. Accordingly, bidding early gives a buyer a competitive advantage over bidding later in the auction, by providing them with a higher final effective bid value for a placed bid of a given initial bid value that they would be obligated to pay in the event of winning the auction.

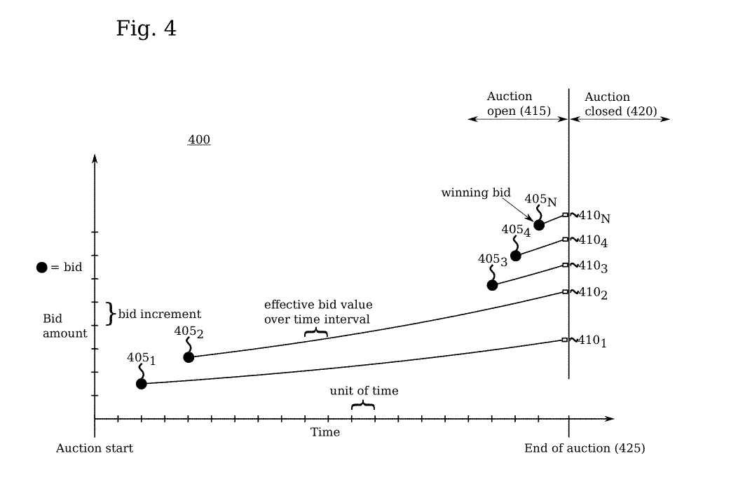

FIG. 4 shows an illustrative timeline 400 of an online auction system that uses an interest rate calculation method or algorithm that compounds the effective bid value of each bid continuously. For every bid 405_{1, 2 . . . N} at every point in time that is during the auction's active period 415, starting from the time the bid is placed 405, the effective bid value is recalculated according to a continuous compound interest method or algorithm and consequently increases by the amount of interest earned on the effective bid value of the respective bid since the last time the effective bid value was calculated. The effective bid value of each bid 405 at the end of the auction 425 is indicated by reference numeral 410_{1, 2 . . . N} and can be considered the respective bid's final effective bid value, as this value does not increase during the auction's closed period 420. The auction system selects the bid that has the highest final effective bid value as the winning bid, which in the illustrative timeline 400 is bid 405_{N} which has a final effective bid value indicated by reference numeral 410_{N}.

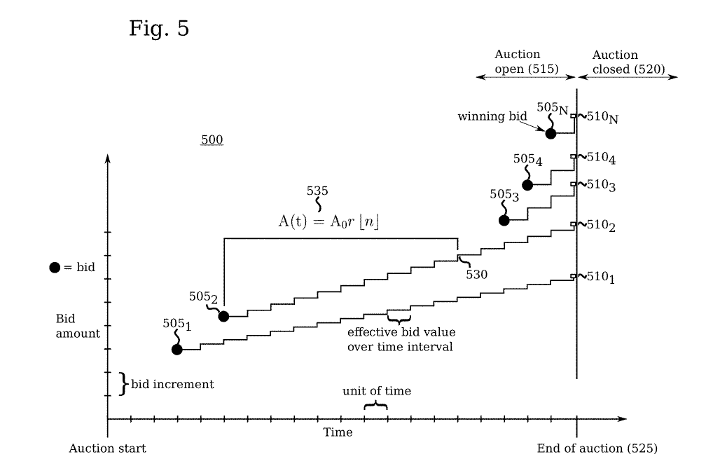

FIG. 5 shows an illustrative timeline 500 of an online auction system employing a simple interest rate algorithm 535 with which the effective bid value of every bid 505_{1, 2 . . . N} increases periodically during the active period of the auction. For every bid 505 after every predetermined time period that is during the auction's active period 515, starting from the time the bid is placed 505, the effective bid value is recalculated according to the simple interest rate algorithm indicated by reference numeral 535 and consequently increases by the amount of interest earned in the preceding time period on the initial bid value of the respective bid. The effective bid value of each bid 505 at the end of the auction 525 is indicated by reference numeral 510_{1, 2 . . . N} and can be considered the respective bid's final effective bid value, which is the effective bid value the bid retains through the auction's closed period 520. At the end of the auction 525, the auction system selects the bid that has the highest final effective bid value as the winning bid, which in the illustrative timeline 500 is bid 505_{N} which has a final effective bid value indicated by reference numeral 510_{N}.

The algorithm 535 in the timeline 500 is depicted calculating the effective bid value of bid 505₂ at time t, which is indicated by reference numeral 530. More precisely, the effective bid value of bid 505₂ at t is defined as

A(t)=A₀r└n┘

where A₀ is the initial bid value of bid 505₂, r is the interest rate per time period of the auction, and n is the number of time periods during the active period 515 that have elapsed from the time bid 505₂ was placed to t, and ⊙n┘ is its discrete value. The simple interest rate algorithm depicted by numeral 535 produces the discrete value of n used to calculate the effective bid value of the bid periodically through an application of the floor math function to n. In some embodiments, the periodic simple interest rate algorithm may produce the discrete value of n by applying the ceiling math function to n.

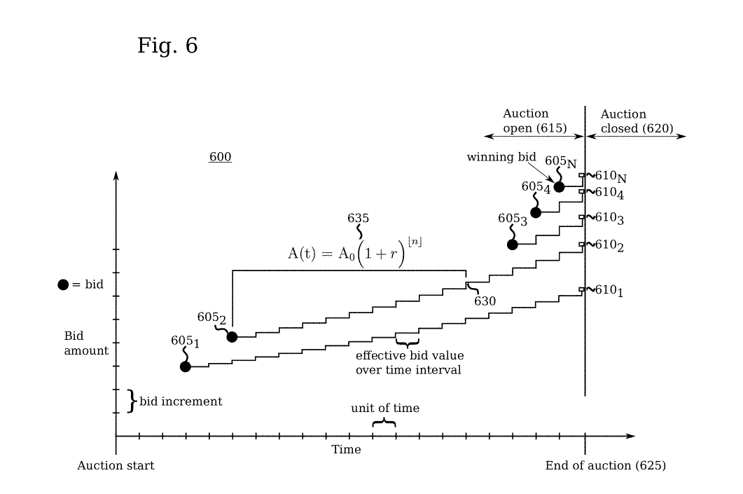

FIG. 6 shows an illustrative timeline 600 of an online auction system employing a compound interest rate algorithm 635 with which the effective bid value of every bid 605_{1, 2 . . . N} increases periodically during the active period of the auction. For every bid 605 after every predetermined time period that is during the auction's active period 615, starting from the time the bid is placed 605, the effective bid value is recalculated according to the compound interest rate algorithm indicated by reference numeral 635 and consequently increases by the amount of interest earned in the preceding time period on the effective bid value of the respective bid. The effective bid value of each bid 605 at the end of the auction 625 is indicated by reference numeral 610_{1, 2 . . . N} and can be considered the respective bid's final effective bid value, which is the effective bid value the bid retains through the auction's closed period 620. At the end of the auction 625, the auction system selects the bid that has the highest final effective bid value as the winning bid, which in the illustrative timeline 600 is bid 605_{N} which has a final effective bid value indicated by reference numeral 610_{N}.

The algorithm 635 in the timeline 600 is depicted calculating the effective bid value of bid 605₂ at time t, which is indicated by reference numeral 630. More precisely, the effective bid value of bid 605₂ at t is defined as

A(t)=A₀(1+r)^{└n┘}

where A₀ is the initial bid value of bid 605₂, r is the interest rate per time period of the auction, and n is the number of time periods during the active period 615 that have elapsed from the time bid 605₂ was placed to t, and └n┘ is its discrete value. The compound interest rate algorithm depicted by numeral 635 produces the discrete value of n used to calculate the effective bid value of the bid periodically through an application of the floor math function to n. In some embodiments, the periodic compound interest rate algorithm may produce the discrete value of n by applying the ceiling math function to n.

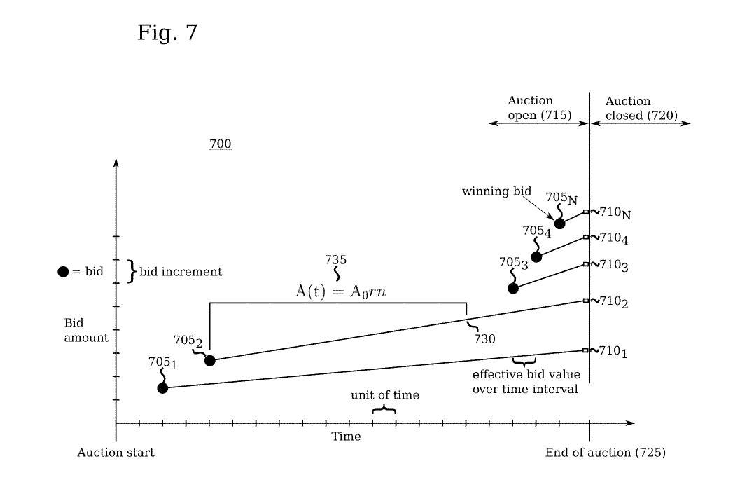

FIG. 7 shows an illustrative timeline 700 of an online auction system employing a simple interest rate algorithm 735 with which the effective bid value of every bid 705_{1, 2 . . . N} increases continuously during the active period of the auction. For every bid 705 at every point in time that is during the auction's active period 715, starting from the time the bid is placed 705, the effective bid value is recalculated according to the simple interest rate algorithm indicated by reference numeral 735 and consequently increases by the amount of interest earned on the initial bid value of the respective bid since the last time the effective bid value was calculated. The effective bid value of each bid 705 at the end of the auction 725 is indicated by reference numeral 710_{1, 2 . . . N} and can be considered the respective bid's final effective bid value, which is the effective bid value the bid retains through the auction's closed period 720. At the end of the auction 725, the auction system selects the bid that has the highest final effective bid value as the winning bid, which in the illustrative timeline 700 is bid 705_{N} which has a final effective bid value indicated by reference numeral 710_{N}.

The algorithm 735 in the timeline 700 is depicted calculating the effective bid value of bid 705₂ at a point in time t, which is indicated by reference numeral 730. More precisely, the effective bid value of bid 705₂ at t is defined as

A(t)=A₀rn

where A₀ is the initial bid value of bid 705₂, r is the interest rate per time period of the auction, and n is the number of time periods during the active period 715 that have elapsed from the time bid 705₂ was placed to t.

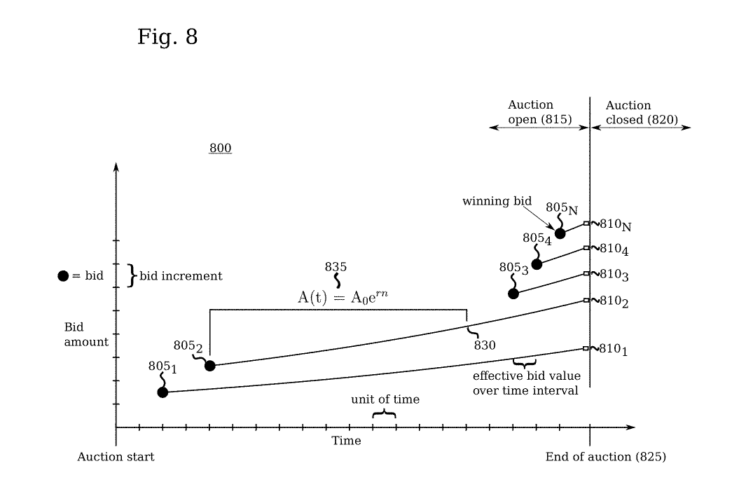

FIG. 8 shows an illustrative timeline 800 of an online auction system employing a compound interest rate algorithm 835 with which the effective bid value of every bid 805_{1, 2 . . . N} increases continuously during the active period of the auction. For every bid 805 at every point in time that is during the auction's active period 815, starting from the time the bid is placed 805, the effective bid value is recalculated according to the compound interest rate algorithm indicated by reference numeral 835 and consequently increases by the amount of interest earned on the effective bid value of the respective bid since the last time the effective bid value was calculated. The effective bid value of each bid 805 at the end of the auction 825 is indicated by reference numeral 810_{1, 2 . . . N} and can be considered the respective bid's final effective bid value, which is the effective bid value the bid retains through the auction's closed period 820. At the end of the auction 825, the auction system selects the bid that has the highest final effective bid value as the winning bid, which in the illustrative timeline 800 is bid 805_{N} which has a final effective bid value indicated by reference numeral 810_{N}.

The algorithm 835 in the timeline 800 is depicted calculating the effective bid value of bid 805₂ at time t, which is indicated by reference numeral 830. More precisely, the effective bid value of bid 805₂ at t is defined as

A(t)=A₀e^{rn}

where A₀ is the initial bid value of bid 805₂, r is the interest rate per time period of the auction, n is the number of time periods during the active period 815 that have elapsed from the time bid 805₂ was placed to t, and e is Napier's constant.

While various embodiments of the invention have been described with respect to the interest algorithm used 535, 635, 735, 835 the embodiments of the invention may be used with other interest rate methods or algorithms.

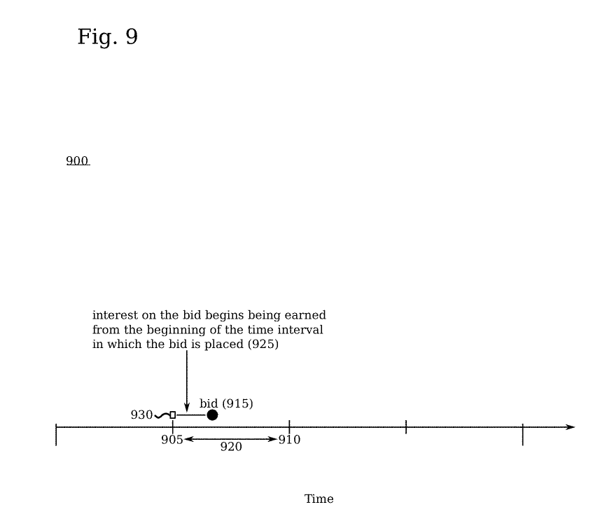

FIG. 9 shows an illustrative timeline 900 of an online auction system in which interest on the effective bid value of a bid 915 begins being earned from the beginning of the time period 920 in which it is placed. The time period 920 is depicted on the timeline 900 as the time interval between the beginning of the time period 905 and the end of the time period 910. The difference in time between when the bid is placed and the time when interest on the bid begins being earned 930 is indicated by reference numeral 925. The time periods in the timeline 900 can be described as having an absolute position and the beginning of the interest earning period of a bid can be described as being rounded down to the beginning of the whole time period in which the bid is placed.

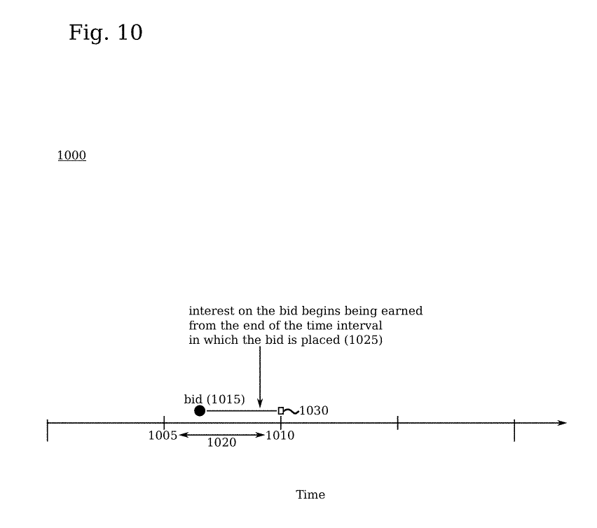

FIG. 10 shows an illustrative timeline 1000 of an online auction system in which interest on the effective bid value of a bid 1015 begins being earned from the end of the time period 1020 in which it is placed. The time period 1020 is depicted on the timeline 1000 as the time interval between the beginning of the time period 1005 and the end of the time period 1010. The difference in time between when the bid is placed and the time when interest on the bid begins being earned 1030 is indicated by reference numeral 1025. The time periods in the timeline 1000 can be described as having an absolute position and the beginning of the interest earning period of a bid can be described as being rounded down to the beginning of the whole time period in which the bid is placed.

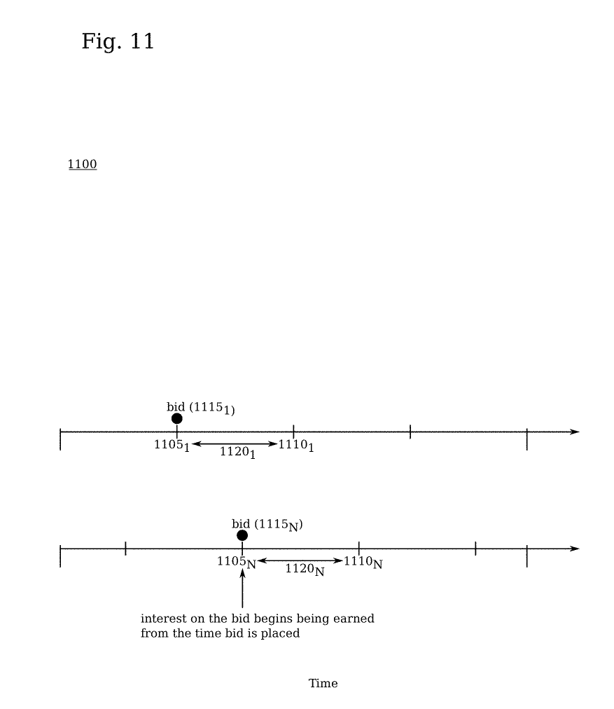

FIG. 11 shows an illustrative timeline 1100 of an online auction system in which interest on the effective bid value of bids begins being earned from the time the bids 1115_{1 . . . N} are placed. The beginning of the time period 1120₁ in which bid 1115₁ is placed is indicated by reference numeral 1105₁ and is located at the same point in the timeline as bid 1115₁. Accordingly, interest on the effective bid value of bid 1115₁ begins being earned at the same point in the timeline as when the bid is placed.

Bid 1115_{N} is placed on the timeline later than the beginning 1105₁ and earlier than the end 1110₁ of the time period 1120₁ in which bid 1115₁ is placed. The beginning of the time period 1120_{N} in which the effective bid value of bid 1115_{N} begins earning interest is indicated by reference numeral 1105_{N} and is located at the same point in the timeline as bid 1115_{N}. Accordingly, interest on the effective bid value of bid 1115_{N} begins being earned later on the timeline than the beginning 1105₁ of the time period 1120₁ in which the effective bid value of bid 1115₁ begins earning interest but before the end 1110₁ of this time period. The time periods in which bid 1115₁ and bid 1115_{N} are placed partially overlap on the timeline. The time periods 1120_{1 . . . N} in the timeline 1100 can be described as having positions that are relative to the positions of their associated bids 1115_{1 . . . N}.

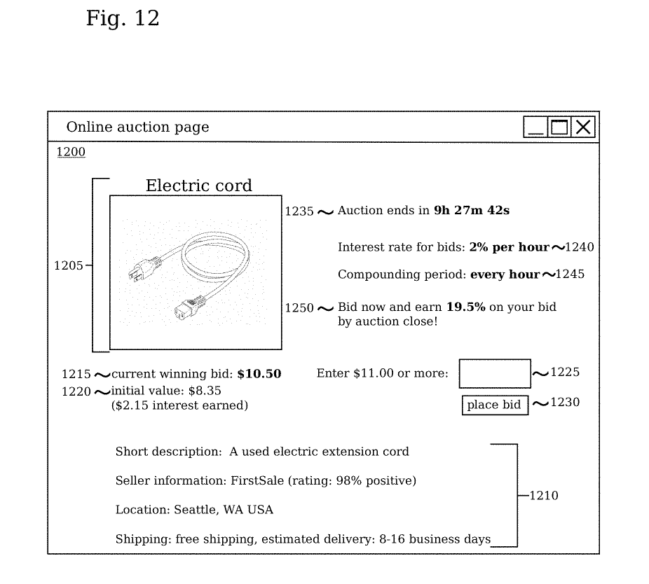

FIG. 12 shows an illustrative user interface screen 1200 to an online auction website that implements an embodiment of the present online auction system and may be run in a browser on a computing device (e.g., one of the computing devices 110 in FIG. 1). In some implementations, the online auction website may be one of the online auction websites 120 shown in FIG. 1. The user interace screen may display an item 1205 for sale and include information 1210 about the item such as, for example, a description of the item and the account name of the item seller, that could assist buyers in assessing the value of the item and deciding whether to bid on it.

The exemplary user interface screen further shows the current winning bid 1215, which, more precisely, can be described as the effective bid value of the winning bid. Accompanying the current winning bid text 1215 is descriptive text 1220 that shows the initial bid value of the current winning bid is, and the interest the bid has earned to date, which is the difference between the initial bid value of the winning bid and the effective bid value of the winning bid 1215.

The user is provided an input text box 1225 to enter their bid and an accompanying input submission button 1230 that when pressed triggers the submission of the bid value entered in the input text box 1225 as a placed bid.

The illustrative user interface screen 1200 further shows the time left until the end of the auction 1235. The interest rate property 1240 and the time period property 1245 of the auction are provided in the user interface screen to inform bidders at what rate the value of their bids will grow in the associated auction. Descriptive text 1250 accompanies the interest rate property 1235 and time period property 1240 text to inform bidders how much the value of their bid will grow over the course of the remainder of the auction's active period if they place their bid at the current time.

In various embodiments where the above-described systems and/or methods for holding an auction are implemented using a programmable device, such as a computer device or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described auction systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the various systems and methods outlined in the FIGS. 1, 2, 3, 4, 5, 6, 7, 8, 9, 10, 11, and 12 above to implement the various steps. That is, the computer could receive various portions of information from the disk relating to different elements of the above-described systems and/or methods, implement the individual systems and/or methods and coordinate the functions of the above-mentioned individual systems and/or methods.

The algorithms, systems, and methods outlined in the above-mentioned drawings can be implemented in software, firmware, or hardware, or using any combination thereof. If programmable logic is used, such logic can execute on a commercially available processing platform or a special purpose device.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed:

1. A method, implemented on at least one computer device, of holding an auction for one or more items, the at least one computer comprising:
at least one memory storing computer-executable instructions; and
at least one processing unit for executing the instructions stored in the memory, wherein execution of the instructions results in the at least one computer performing the steps of:
defining a plurality of auction properties comprising:
(i) an interest rate, and
(ii) a time period;
accepting, from one or more item buyers through user input on their respective device, at least one bid for the items, each bid having associated bid attributes comprising a bidder and an initial bid value;
the bid attributes of each bid further comprising an effective bid value that is initially set to equal the initial bid value of the bid;
after the time period adjusting the effective bid value of each bid by setting the effective bid value to equal the sum of the effective bid value and the interest the bid earned according to the interest rate property of the associated auction;
determining the winning bid based on the effective bid values of the bids placed; and
determining the amount owed by the winning bidder by the initial bid value of their winning bid.

2. The method of claim 1, wherein acceptance of a new bid requires the bid meeting the bid value threshold of the auction.

3. The method of claim 2, wherein the determination of the bid value threshold of the auction comprises:
(a) selecting, as an evaluated bid, the bid with the highest bid effective value; and
(b) setting the bid value threshold to equal the sum of a predetermined increment and the effective bid value of the evaluated bid.

4. The method of claim 1, wherein after the time period adjusting the effective bid value of each bid by setting the effective bid value to equal the sum of the effective bid value and the interest the bid earned according to the interest rate property of the associated auction comprises:
(a) setting the interest the bid earned in the preceding time period to equal the percentage of the initial bid value of the bid that is equal to the interest rate of the auction;
(b) setting the new effective bid value of the bid to equal the sum of the current effective bid value of the bid and the interest the bid earned in the preceding time period.

5. The method of claim 1, wherein after the time period adjusting the effective bid value of each bid by setting the effective bid value to equal the sum of the effective bid value and the interest the bid earned according to the interest rate property of the associated auction comprises:
(a) setting the interest the bid earned in the preceding time period to equal the percentage of the effective bid value of the bid that is equal to the interest rate of the auction;
(b) setting the new effective bid value of the bid to equal the sum of the current effective bid value of the bid and the interest the bid earned in the preceding time period.

6. The method of claim 1, wherein the auction is a real-time bidding auction.

7. The method of claim 1, wherein the auction properties further comprise a compounding frequency.

8. The method of claim 7, wherein the compounding frequency auction property has associated compounding frequency attributes comprising a base time value and a number of occurrences value.

9. The method of claim 8, wherein the determination of the time period property of the auction comprises:
setting the time period property of the auction to equal the result of the division of the base time value associated with the compounding frequency by the number of occurrences value associated with the compounding frequency.

10. The method of claim 1, wherein the auction properties further comprise a minimum bid.

11. The method of claim 1, wherein the auction properties further comprise a reserve price.

12. The method of claim 10, wherein after the time period the minimum bid is adjusted by setting the minimum bid to equal the sum of the minimum bid and the interest the minimum bid earned in the preceding time period according to the interest rate property of the associated auction.

13. The method of claim 11, wherein after the time period the reserve price is adjusted by setting the reserve price to equal the sum of the reserve price and the interest the reserve price earned in the preceding time period according to the interest rate property of the associated auction.

14. A system of holding an auction for one or more items, the system comprising:
at least one memory storing computer-executable instructions; and
at least one processing unit for executing the instructions stored in the memory, wherein execution of the instructions results in one or more application modules together comprising:
an auction property module for defining a plurality of auction properties comprising:
(i) an interest rate, and
(ii) a time period;
an item bus module for:
accepting, from one or more item buyers, at least one bid for the items, each bid having associated bid attributes comprising a bidder and an initial bid value;
the bid attributes of each bid further comprising an effective bid value that is initially set to equal the initial bid value of the bid;
after the time period adjusting the effective bid value of each bid by setting the effective bid value to equal the sum of the effective bid value and the interest the bid earned according to the interest rate property of the associated auction;
determining the winning bid based on the effective values of the bids placed; and
determining the amount owed by the winning bidder by the initial bid value of their winning bid.

15. The system of claim 14, wherein acceptance of a new bid requires the bid meeting the bid value threshold of the auction.

16. The system of claim 15, wherein the determination of the bid value threshold of the auction comprises:
(a) selecting, as an evaluated bid, the bid with the highest effective bid value; and
(b) setting the bid value threshold to equal the sum of a predetermined increment and the effective bid value of the evaluated bid.

17. The system of claim 14, wherein after the time period adjusting the effective bid value of each bid by setting the effective bid value to equal the sum of the effective bid value and the interest the bid earned according to the interest rate property of the associated auction comprises:
(a) setting the interest the bid earned in the preceding time period to equal the percentage of the initial bid value of the bid that is equal to the interest rate of the auction;
(b) setting the new effective bid value of the bid to equal the sum of the current effective bid value of the bid and the interest the bid earned in the preceding time period.

18. The system of claim 14, wherein after the time period adjusting the effective bid value of each bid by setting the effective bid value to equal the sum of the effective bid value and the interest the bid earned according to the interest rate property of the associated auction comprises:
(a) setting the interest the bid earned in the preceding time period to equal the percentage of the effective bid value of the bid that is equal to the interest rate of the auction;
(b) setting the new effective bid value of the bid to equal the sum of the current effective bid value of the bid and the interest the bid earned in the preceding time period.

19. The system of claim 14, wherein the auction is a real-time bidding auction.

20. The system of claim 14, wherein the auction properties further comprise a compounding frequency.

21. The system of claim 20, wherein the compounding frequency auction property has associated compounding frequency attributes comprising a base time value and a number of occurrences value.

22. The system of claim 21, wherein the determination of the time period property of the auction comprises:
setting the time period property of the auction to equal the result of the division of the base time value associated with the compounding frequency by the number of occurrences value associated with the compounding frequency.

23. The system of claim 14, wherein the auction properties further comprise a minimum bid.

24. The system of claim 14, wherein the auction properties further comprise a reserve price.

25. The system of claim 23, wherein after the time period the minimum bid is adjusted by setting the minimum bid to equal the sum of the minimum bid and the interest the minimum bid earned in the preceding time period according to the interest rate property of the associated auction.

26. The system of claim 24, wherein after the time period the reserve price is adjusted by setting the reserve price to equal the sum of the reserve price and the interest the reserve price earned in the preceding time period according to the interest rate property of the associated auction.

27. An article of manufacture comprising: a computer storage medium; computer program instructions stored on the computer storage medium which, when processed by a processing device, instruct the processing device to perform a process of executing the steps of:
defining a plurality of auction properties comprising:
(i) an interest rate, and
(ii) a time period;
accepting, from one or more item buyers through user input on their respective device, at least one bid for the items, each bid having associated bid attributes comprising a bidder and an initial bid value;
the bid attributes of each bid further comprising an effective bid value that is initially set to equal the initial bid value of the bid;
after the time period adjusting the effective bid value of each bid by setting the effective bid value to equal the sum of the effective bid value and the interest the bid earned according to the interest rate property of the associated auction;
determining the winning bid based on the effective bid values of the bids placed; and
determining the amount owed by the winning bidder by the initial bid value of their winning bid.

28. The article of manufacture in claim 27, wherein acceptance of a new bid requires the bid meeting the bid value threshold of the auction.

29. The article of manufacture in claim 28, wherein the determination of the bid value threshold of the auction comprises:
(a) selecting, as an evaluated bid, the bid with the highest bid effective value; and
(b) setting the bid value threshold to equal the sum of a predetermined increment and the effective bid value of the evaluated bid.

30. The article of manufacture in claim 27, wherein after the time period adjusting the effective bid value of each bid by setting the effective bid value to equal the sum of the effective bid value and the interest the bid earned according to the interest rate property of the associated auction comprises:
(a) setting the interest the bid earned in the preceding time period to equal the percentage of the initial bid value of the bid that is equal to the interest rate of the auction;
(b) setting the new effective bid value of the bid to equal the sum of the current effective bid value of the bid and the interest the bid earned in the preceding time period.

31. The article of manufacture in claim 27, wherein after the time period adjusting the effective bid value of each bid by setting effective bid value to equal the sum of the effective bid value and the interest the bid earned according to the interest rate property of the associated auction comprises:
(a) setting the interest the bid earned in the preceding time period to equal the percentage of the effective bid value of the bid that is equal to the interest rate of the auction;
(b) setting the new effective bid value of the bid to equal the sum of the current effective bid value of the bid and the interest the bid earned in the preceding time period.

32. A computer with a graphical user interface for displaying an auction, comprising a display; memory storing a plurality of auction properties comprising:
(i) an interest rate, and
(ii) a time period;
a processor configured to:
accept, from one or more item buyers through user input on their respective device, at least one bid for the items, each bid having associated bid attributes comprising a bidder and an initial bid value, and store the bids and associated bid attributes in memory;
the bid attributes of each bid further comprising an effective bid value that is initially set to equal the initial bid value of the bid;
after the time period adjusting the effective bid value of each bid by setting the effective bid value to equal the sum of the effective bid value and the interest the bid earned according to the interest rate property of the associated auction;
determining the winning bid based on the effective bid values of the bids placed; and
determining the amount owed by the winning bidder by the initial bid value of their winning bid.
